(19) United States
(12) Patent Application Publication
(10) Pub. No.: US 2016/0268953 A1
(43) Pub. Date: Sep. 15, 2016

(54) CONTROL CIRCUIT, SEMICONDUCTOR DEVICE, AND CONSTANT VOLTAGE OUTPUT METHOD

(71) Applicant: KABUSHIKI KAISHA TOSHIBA, Tokyo (JP)

(72) Inventor: Takashi KAMISHINBARA, Kawasaki Kanagawa (JP)

(21) Appl. No.: 14/842,165

(22) Filed: Sep. 1, 2015

(30) Foreign Application Priority Data
Mar. 13, 2015 (JP) 2015-051395

(51) Int. Cl. H02P 29/02; H02P 27/06; H02P 6/14

(52) U.S. Cl. CPC H02P 29/027; H02P 6/14; H02P 27/06

(57) ABSTRACT

According to an embodiment, a control circuit includes a switch circuit and a constant voltage circuit. The switch circuit switches from an OFF state to an ON state when an input voltage of a control signal for controlling operation (driving) of a motor exceeds a threshold value. The constant voltage circuit generates a constant voltage and outputs the constant voltage based on a voltage supplied via the switch circuit.

### CROSS-REFERENCE TO RELATED APPLICATION

This application is based upon and claims the benefit of priority from Japanese Patent Application No. 2015-051395, filed Mar. 13, 2015, the entire contents of which are incorporated herein by reference.

### FIELD

Embodiments described herein relate generally to a control circuit, a semiconductor device, and a constant voltage output method.

### BACKGROUND

Motors incorporated in home appliances, such as air conditioners or washing machines, require not only reductions in power consumption during motor operation, but also reductions in standby power consumption.

Such motors are generally driven by a motor drive circuit, and the motor drive circuit is controlled by a control circuit. The control circuit generally includes a regulator circuit, a drive circuit, a protection circuit, and the like.

When the control circuit is connected to a power supply unit, the regulator circuit receives a voltage from the power supply unit. Thus, even when the motor is not being driven, the regulator circuit still supplies a constant voltage to the drive circuit, the protection circuit, or the like, during standby and as such the standby power usage can be substantial.

### DESCRIPTION OF THE DRAWINGS

FIG. 1 is a block diagram illustrating a schematic circuit configuration of a semiconductor device according to a first embodiment.

FIG. 2 is a diagram illustrating a schematic circuit configuration of a regulator according to the first embodiment.

FIG. 3A is a timing chart illustrating a constant voltage output operation of a control circuit according to a comparison example, and FIG. 3B is a timing chart illustrating a constant voltage output operation of a control circuit according to the first embodiment.

### DETAILED DESCRIPTION

Example embodiments provide a control circuit, a semiconductor device, and a constant voltage output method which can reduce standby power consumption.

In general, according to one embodiment, a control circuit includes a switch circuit and a constant voltage circuit. The switch circuit is configured to switch from an OFF state to an ON state when an input voltage of a control signal for controlling operation (driving) of a motor exceeds a predetermined threshold value that is a threshold value that has been previously set. The constant voltage circuit is configured to generate a constant voltage and output the constant voltage based on a voltage which is supplied via the switch circuit. For example, the control signal may control the number of rotations of the motor according to the input voltage value.

Hereinafter, an embodiment will be described with reference to the drawings. The presented examples are for purposes of explanation and the present disclosure is not specifically limited to these example embodiments.

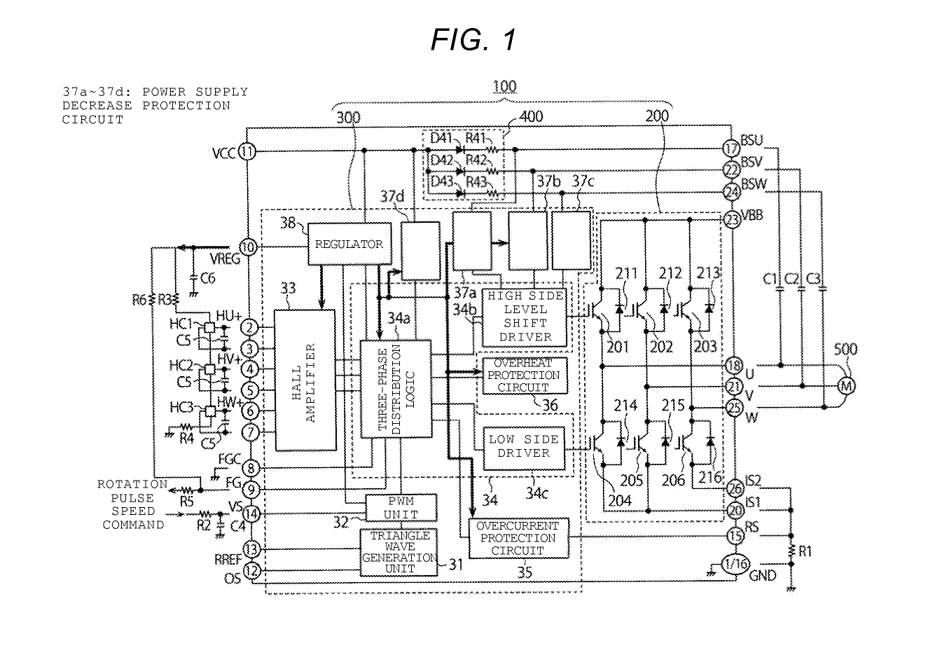

FIG. 1 is a block diagram illustrating a schematic circuit configuration of a semiconductor device according to an embodiment. FIG. 1 illustrates not only a semiconductor device 100 according to the present embodiment, but also other electronic components that are externally attached to the semiconductor device 100 in order to drive a motor 500. In the present embodiment, the motor 500 is a three-phase DC brushless motor, but may be other types of motors, such as a motor with a three-phase DC brush, a single phase DC brushless motor, or a motor with a single phase DC brush.

As illustrated in FIG. 1, the semiconductor device 100 includes a motor drive circuit 200, a control circuit 300, and a charging circuit 400. Schematically, the motor drive circuit 200 drives the motor 500, the control circuit 300 controls the motor drive circuit 200, and the charging circuit 400 charges bootstrap capacitors C1 to C3 that are externally attached to the semiconductor device 100.

Motor Drive Circuit 200

As illustrated in FIG. 1, the motor drive circuit 200 includes the switching elements 201 to 206 that perform switching operation based on the control of the control circuit 300, and reflux diodes 211 to 216 that are connected in parallel with each of the switching elements 201 to 206. In the present embodiment, the switching elements 201 to 206 are insulated gate bipolar transistors (IGBTs). The switching elements 201 to 206 may be other types of switching elements.

As illustrated in FIG. 1, the switching element 201 is connected in series to the switching element 204. The emitter of the switching element 201 and the collector of the switching element 214 are connected to a U phase output terminal 18 (U terminal). In the same manner, the switching element 202 and the switching element 205 are also connected in series to each other. The emitter of the switching element 202 and the collector of the switching element 205 are connected to a V phase output terminal 21 (V terminal). Furthermore, the switching element 203 and the switching element 206 are also connected in series to each other. The emitter of the switching element 203 and the collector of the switching element 206 are connected to a W phase output terminal 25 (W terminal). The U phase output terminal 18, the V phase output terminal 21, and the W phase output terminal 25 are connected to the motor 500.

In addition, the collectors of switching elements 201 to 203 are connected to a high voltage power supply terminal 23 (VBB terminal). The emitters of the switching elements 204 and 205 are connected to an emitter/anode terminal 20 (IS1 terminal). The emitter of the switching element 206 is connected to an emitter/anode terminal 26 (IS2 terminal). The emitter/anode terminals 20 and 26 are connected to ground terminals 1 and 16 (GND terminal) via an externally attached resistor R1. When the motor 500 is driven, a DC voltage is applied between the high voltage power supply terminal 23 and the ground terminals 1 and 16.

Control Circuit 300

As illustrated in FIG. 1, the control circuit 300 includes a triangle wave generation unit 31, a pulse wide modulation (PWM) unit 32, a hall amplifier 33, a drive circuit 34, an overcurrent protection circuit 35, an overheat protection circuit 36, power supply decrease protection circuits 37a to 37d, and a regulator 38.

Triangle Wave Generation Unit 31

A frequency setting signal is input to the triangle wave generation unit 31 from the outside via input terminals 12 and 13 (OS terminal, RREF terminal). The triangle wave generation unit 31 outputs a triangle wave with a frequency corresponding to the frequency setting signal that is input, to the PWM unit 32.

PWM Unit 32

A speed control signal is input to the PWM unit 32 from the outside via a speed control signal (speed command) input terminal 14 (VS terminal). The PWM unit 32 generates a PWM signal based on the speed control signal and a triangle wave that is input from the triangle wave generation unit 31, and outputs the generated PWM signal to the drive circuit 34. The externally attached resistor R2 and the externally attached capacitor C4 are connected to the speed control signal input terminal 14. The speed control signal is an example of a motor drive control signal for controlling the drive of the motor 500. The number of rotations of the motor 500 is controlled, based on a voltage of the speed control signal that is input to the speed control signal input terminal 14.

In addition, the PWM unit 32 outputs an output control signal that indicates whether or not an input voltage of the speed control signal exceeds a threshold value to the drive circuit 34 and the regulator 38.

Hall Amplifier 33

The hall amplifier 33 amplifies rotation positional signals that are input from each of externally attached hall sensors HC1 to HC3, and outputs the amplified signals to the drive circuit 34. The rotation positional signals indicate a rotation position of the motor 500. The externally attached hall sensor HC1 is connected to the hall amplifier 33 via input terminals 2 and 3 (HU+ terminal, HU− terminal). In the same manner, the externally attached hall sensor HC2 is also connected to the hall amplifier 33 via input terminals 4 and 5 (HV+ terminal, HV− terminal). Furthermore, the externally attached hall sensor HC3 is also connected to the hall amplifier 33 via input terminals 6 and 7 (HW+ terminal, HW− terminal).

The externally attached capacitor C5 is connected between the input terminal 2 and the input terminal 3. In the same manner, the externally attached capacitor C5 is connected between the input terminal 4 and the input terminal 5. Furthermore, the externally attached capacitor C5 is connected between the input terminal 6 and the input terminal 7. In addition, the externally attached capacitors HC1 to HC3 are connected to a regulator output terminal 10 (VREG terminal) via the externally attached resistor R3, and are grounded via the externally attached resistor R4. The externally attached capacitor C6 is connected to the regulator output terminal 10.

Drive Circuit 34

The drive circuit 34 includes a three-phase distribution logic 34a, a high side level shift driver 34b, and a low side driver 34c.

The three-phase distribution logic 34a respectively outputs the PWM signal that is input from the PWM unit 32 to the high side level shift driver 34b and the low side driver 34c, based on the rotation positional signal that is input from the hall amplifier 33.

In addition, the three-phase distribution logic 34a is connected to a pulse number switching terminal 8 (FGC terminal) and a rotation pulse output terminal 9 (FG terminal). The pulse number switching terminal 8 is grounded. The rotation pulse output terminal 9 is connected to the externally attached resistor R5, and is connected to the regulator output terminal 10 via the externally attached resistor R6. The pulse number switching terminal 8 sets the number of pulse signals that are output from the rotation pulse output terminal 9. For example, when the number of pulse signals is set as “1” in the pulse number switching terminal 8, one pulse signal is output from the rotation pulse output terminal 9 in each time that the motor 500 rotates once.

The high side level shift driver 34b controls switching operations of the high side switching elements 201 to 203, based on the PWM signal that is input from the three-phase distribution logic 34a. The low side driver 34c controls switching operations of the low side switching elements 204 to 206, based on the PWM signal that is input from the three-phase distribution logic 34a.

Overcurrent Protection Circuit, Overheat Protection Circuit, Power Supply Decrease Protection Circuit

The overcurrent protection circuit 35, the overheat protection circuit 36, and the power supply decrease protection circuits 37a to 37d are all a protection circuit for protecting the motor drive circuit 200. Hereinafter, each protection circuit will be described.

The overcurrent protection circuit 35 detects a voltage of an externally attached resistor R1 via an overcurrent detection terminal 15, and outputs a current detection signal that indicates whether or not the detected voltage exceeds an allowable value to the three-phase distribution logic 34a. When the detected voltage exceeds the allowable value, the three-phase distribution logic 34a stops outputting the PWM signal to the high side level shift driver 34b and the low side driver 34c.

The overheat protection circuit 36 detects temperature of the motor drive circuit 200, and outputs a temperature detection signal that indicates whether or not the detected temperature exceeds an allowable value to the three-phase distribution logic 34a. When the detected temperature exceeds the allowable value, the three-phase distribution logic 34a stops outputting the PWM signal to the high side level shift driver 34b and the low side driver 34c.

The power supply decrease protection circuits 37a to 37c are connected to a control power supply terminal 11 (VCC terminal) via the charging circuit 400. The power supply decrease protection circuit 37d is directly connected to the control power supply terminal 11 without passing through the charging circuit 400. A DC voltage is supplied to the control power supply terminal 11 from an external control power supply. In the present embodiment, a DC voltage of 15 V is supplied to the control circuit 300 via the control power supply terminal 11.

The power supply decrease protection circuits 37a to 37c detects an output voltage of the charging circuit 400, and outputs a voltage detection signal that indicates whether or not the detected output voltage is equal to or lower than an allowable value to the high side level shift driver 34b. When the output voltage of the charging circuit 400 is equal to or lower than the allowable value, the high side level shift driver 34b stops outputting of the PWM signal to the high side switching elements 201 to 203.

The power supply decrease protection circuit 37d detects the output voltage of the control power supply terminal 11, and outputs a voltage detection signal that indicates whether or not the detected output voltage is equal to or lower than an allowable value to the three-phase distribution logic 34a. When the detected output voltage is equal to or lower than the allowable value, the three-phase distribution logic 34a stops outputting the PWM signal to the low side driver 34c.

The control circuit 300 according to the present embodiment includes at least the three types of protection circuits described above, but the control circuit 300 may include other protection circuits in addition to the three described above or may include just one or two of the three described above.

Regulator 38

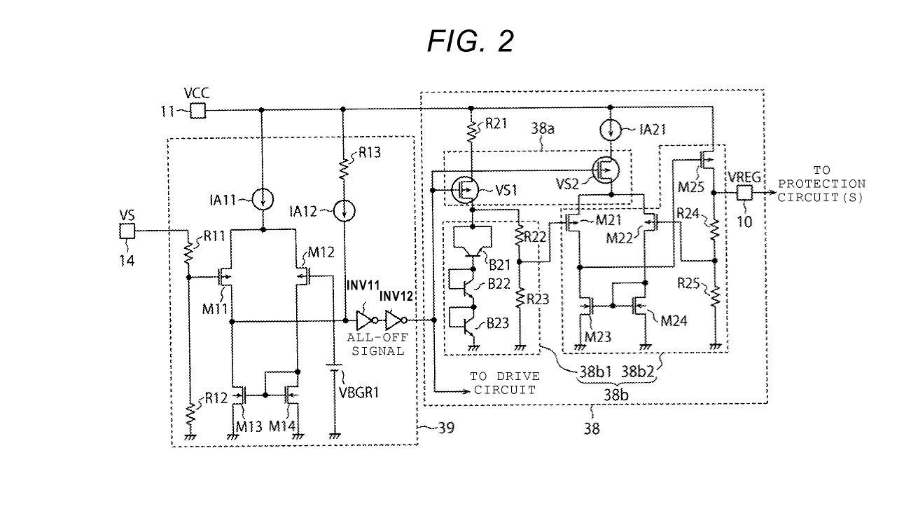

FIG. 2 is a diagram illustrating a schematic circuit configuration of a regulator 38. FIG. 2 illustrates not only the regulator 38 but also a comparison circuit 39. Firstly, the comparison circuit 39 will be described before the regulator 38 is described.

As illustrated in FIG. 2, the comparison circuit 39 includes resistors R11 to R13, constant current sources IA11 and IA12, MOS transistors M11 to M14, inverter circuits INV11 and INV12, and a band gap regulator VBGR1. The comparison circuit 39 according to the present embodiment is provided inside the PWM unit 32 described above, but the comparison circuit 39 may instead be provided outside of the PWM unit 32.

The resistor R11 is connected to the speed control signal input terminal 14. The resistor R12 is connected in series to the resistor R11. The resistor R13 is connected to the control power supply terminal 11. The constant current source IA11 is connected to the control power supply terminal 11. The constant current source IA12 is connected to the control power supply terminal 11 via the resistor R13.

The gate of the MOS transistor M11 is connected between the resistor R11 and the resistor R12. The source of the MOS transistor M11 is connected to the constant current source IA11. The drain of the MOS transistor M11 is connected to the drain of the MOS transistor M13.

The gate of the MOS transistor M12 is connected to the band gap regulator VBGR1. The source of the MOS transistor M12 is connected to the constant current source IA11. The drain of the MOS transistor M12 is connected to the drain of the MOS transistor M14.

The gate of the MOS transistor M13 is connected to the gate of the MOS transistor M14. In addition, the MOS transistor M14 includes the gate and drain that are connected to each other. As a result, the MOS transistor M13 and the MOS transistor M14 configure a current mirror circuit.

The inverter circuit INV11 is connected between the drain of the MOS transistor M11 and the drain of the MOS transistor M13, and is connected to the constant current source IA12. The inverter circuit INV12 is connected in series to the inverter circuit INV11.

In the comparison circuit 39 configured as described above, when a speed control signal is input to the speed control signal input terminal 14, the input voltage of the speed control signal is divided by the resistor R11 and the resistor R12. Then, when the divided value is equal to or less than the voltage of the band gap regulator VBGR1, the MOS transistor M11 turns ON, and the MOS transistor M12 turns OFF. In this case, the inverter circuit INV12 outputs a first output control signal indicating that the input voltage of the speed control signal does not exceed a threshold value, to the three-phase distribution logic 34a and the regulator 38.

Meanwhile, when the divided value of the speed control signal exceeds the voltage of the band gap regulator VBGR1, the MOS transistor M11 turns OFF, and the MOS transistor M12 turns OFF. In this case, the inverter circuit INV12 outputs a second output control signal indicating that the input voltage of the speed control signal exceeds the threshold value, to the three-phase distribution logic 34a and the regulator 38.

In other words, the comparison circuit 39 compares the input voltage of the speed control signal with the threshold value, and outputs the output control signal indicating whether or not the input voltage exceeds the threshold value, to the three-phase distribution logic 34a and the regulator 38.

As illustrated in FIG. 2, the regulator 38 includes a switching circuit 38a and a constant voltage circuit 38b.

The switching circuit 38a includes a MOS transistor VS1 (first switch) and a MOS transistor VS2 (second switch). The gate of the MOS transistor VS1 is connected to the inverter circuit INV12. The source of the MOS transistor VS1 is connected to the control power supply terminal 11 via the resistor R21. The drain of the MOS transistor VS1 is connected to the constant voltage circuit 38b.

The gate of the MOS transistor VS2 is connected to the inverter circuit INV12. The source of the MOS transistor VS2 is connected to the control power supply terminal 11 via a constant current source IA21. The drain of the MOS transistor VS2 is connected to the constant voltage circuit 38b.

In the switching circuit 38a configured as described above, when the inverter circuit INV12 outputs the first speed control signal to each of the gates of the MOS transistors VS1 and VS2, both of the MOS transistors VS1 and VS2 turn OFF. In contrast to this, when the inverter circuit INV12 outputs the second speed control signal to each of the gates of the MOS transistors VS1 and VS2, both of the MOS transistors VS1 and VS2 turn ON state.

In the present embodiment, the switching circuit 38a includes the MOS transistors VS1 and VS2, but the switching circuit 38a may also comprise other types of switching elements other than a MOS transistor.

Next, the constant voltage circuit 38b will be described. The constant voltage circuit 38b includes a reference voltage circuit 38b1 and a feedback circuit 38b2.

The reference voltage circuit 38b1 includes bipolar transistors B21 to B23, and resistors R22 and R23. The collector and emitter of the bipolar transistor B21 are connected to the drain of the MOS transistor VS1. For this reason, the bipolar transistor B21 corresponds to a diode that uses the collector and the emitter as anodes. The bipolar transistor B22 is connected to the base (the cathode of a diode) of the bipolar transistor B21. The bipolar transistor B23 is connected in series to the bipolar transistor B22. The bipolar transistors B22 and B23 have bases and collectors that are connected to each other. For this reason, the bipolar transistors B22 and B23 correspond to a diode that uses the base as an anode and uses the emitter as a cathode.

The resistor R22 is connected to the drain of the MOS transistor VS1. The resistor R23 is connected in series to the resistor R22.

The feedback circuit 38b2 includes MOS transistors M21 to M25, and resistors R24 and R25.

The gate of the MOS transistor M21 is connected between the resistor R22 and the resistor R23. The source of the MOS transistor M21 is connected to the drain of the MOS transistor VS2. The drain of the MOS transistor M21 is connected to the drain of the MOS transistor M23.

The gate of the MOS transistor M22 is connected between the resistor R24 and the resistor R25. The source of the MOS transistor M22 is connected to the drain of the MOS transistor VS2. The drain of the MOS transistor M22 is connected to the drain of the MOS transistor M24.

The gate of the MOS transistor M23 is connected to the gate of the MOS transistor M24. In addition, the MOS transistor M24 includes a gate and a drain that are connected to each other. The MOS transistor M23 and the MOS transistor M24 configure a current mirror circuit.

The resistor R24 is connected to the regulator output terminal 10. The resistor R25 is connected in series to the resistor R24.

In the constant voltage circuit 38b configured as described above, when the switching circuit 38a is changed from an OFF state to an ON state, a DC voltage that is input to the control power supply terminal 11 is supplied to the reference voltage circuit 38b1 via the switching circuit 38a, and a constant current that is output from a constant current source IA21 is supplied to the feedback circuit 38b2.

The reference voltage circuit 38b1 generates a reference voltage based on the supplied DC voltage. The reference voltage corresponds to a voltage of the regulator output terminal 10, that is, a constant voltage (6 V in the present embodiment) that is supplied to the hall amplifier 33, a drive circuit 34, various protection circuits, or the like.

Meanwhile, the feedback circuit 38b2 compares a reference voltage that is generated in the reference voltage circuit 38b1 with a voltage of the regulator output terminal 10, and controls an output current of the MOS transistor M25 based on a comparison result. As a result, even when a DC voltage that is input to the control power supply terminal 11 is changed, a current that flows in the resistors R24 and R25 is adjusted, whereby a voltage of the regulator output terminal 10 is maintained as a constant voltage.

Charging Circuit 400

Returning to FIG. 1 again, the charging circuit 400 includes diodes D41 to D43, and resistors R41 and R43. The anodes of the diodes D41 to D43 are respectively connected to the control power supply terminal 11. The cathode of the diode D41 is connected to a U phase boot strap capacitor connection terminal 17 (BSU terminal) via the resistor R41. The U phase boot strap capacitor connection terminal 17 is connected to a boot strap capacitor C1. The cathode of the diode D42 is connected to a V phase boot strap capacitor connection terminal 22 (BSV terminal) via the resistor R42. The V phase boot strap capacitor connection terminal 22 is connected to a boot strap capacitor C2. The cathode of the diode D43 is connected to a W phase boot strap capacitor connection terminal 24 (BSW terminal) via the resistor R43. The W phase boot strap capacitor connection terminal 24 is connected to a boot strap capacitor C3.

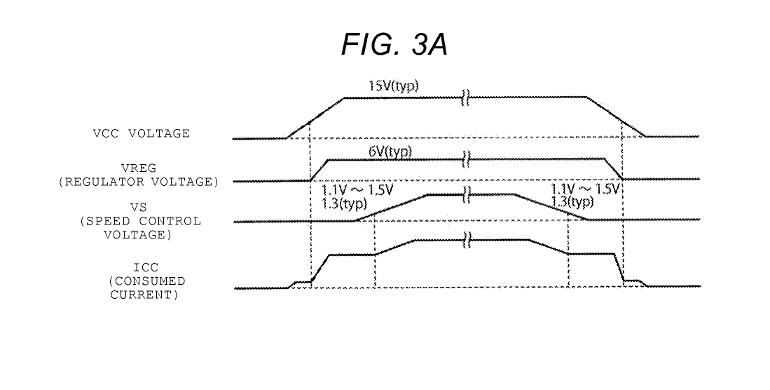

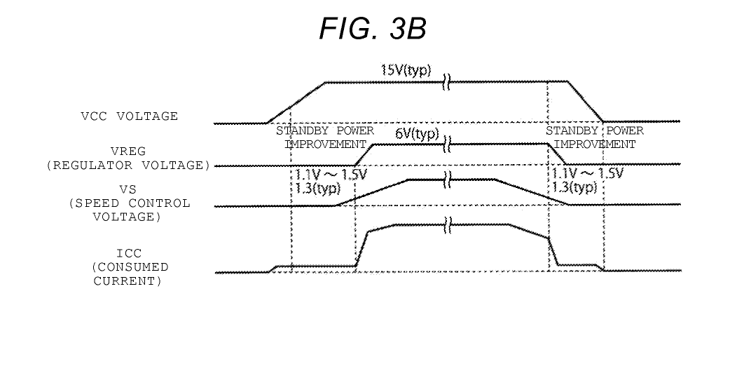

Next, a constant voltage output operation of the control circuit 300 according to the present embodiment will be described with reference to FIGS. 3A and 3B. FIG. 3A is a timing chart illustrating a constant voltage output operation of a control circuit according to a comparison example, and FIG. 3B is a timing chart illustrating the constant voltage output operation of the control circuit according to the present embodiment. A configuration of the control circuit according to the comparison example is similar to that of the control circuit 300 according to the present embodiment except the present comparison example does not include the switching circuit 38a described above.

A VCC voltage in FIGS. 3A and 3B indicates a DC voltage that is supplied to the control circuit. VREG (regulator voltage) indicates an output voltage of the constant voltage circuit. VS (speed control voltage) indicates an input voltage of the speed control signal. ICC (consumed current) indicates a consumed current of the control circuit. The designation “(typ)” in FIGS. 3A and 3B after various voltage values indicates a typical or a standard value adopted in in some operational devices. For example, 1.3 V that is denoted in a waveform of VS is a standard value, and variation of 1.1 V to 1.5 V is allowed. However, in general, the depicted voltage values are examples only and other values may be adopted in some embodiments.

As illustrated in FIG. 3A, the switching circuit 38a is not provided in the control circuit according to the comparison example, whereby VREG operates in accordance with the VCC voltage. For this reason, when the VCC voltage is supplied to the control circuit, a voltage is immediately supplied to the constant voltage circuit. That is, a voltage is supplied to the constant voltage circuit before the input voltage of the speed control signal exceeds 1.3 V.

In addition, after the input voltage of the speed control signal exceeds 1.3 V, a continuous voltage is supplied to the constant voltage circuit even for a time after the input voltage again becomes equal to or less than 1.3 V again. As a result, even when the input voltage of the speed control signal is decreased to a voltage equal to or lower than 1.3 V, the constant voltage circuit continuously supplies a constant voltage to the hall amplifier, the drive circuit, various protection circuits, or the like. Thus, VREG also decreases in accordance with the decrease of the VCC voltage.

However, in the control circuit according to the comparison example, the switching element does not perform a switching operation until the input voltage of the speed control signal exceeds 1.3 V. That is, in the control circuit according to the comparison example, the constant voltage circuit supplies a constant voltage to the hall amplifier 33, the drive circuit 34, various protection circuits, or the like, regardless of stopping the motor 500.

However, as illustrated in FIG. 3B, in the control circuit 300 according to the present embodiment, when the input voltage of the speed control signal is equal to or lower than 1.3 V, the inverter circuit INV12 of the comparison circuit 39 outputs the first output control signal described above to the switching circuit 38a. At this time, the switching circuit 38a is kept in an OFF state, and thus a voltage is not supplied to the constant voltage circuit 38b. As a result, VREG is zero. At this time, the three-phase distribution logic 34a does not output the PWM signal to any one of the high side level shift driver 34b and the low side driver 34c. That is, the first output control signal corresponds to an all-OFF signal that turns off all the switching elements 201 to 206.

Thereafter, when the input voltage of the speed control signal exceeds 1.3 V, the inverter circuit INV12 outputs the second output control signal described above to the switching circuit 38a. At this time, the switching circuit 38a is changed from an OFF state to an ON state. Owing to this, a voltage is supplied to the constant voltage circuit 38b via the switching circuit 38a. As a result, after a transition period, VREG increases from zero and becomes a constant voltage (6 V). This constant voltage is supplied to the hall amplifier 33, the drive circuit, various protection circuits, or the like.

In addition, when the input voltage of the speed control signal exceeds 1.3 V, the three-phase distribution logic 34a outputs the PWM signal to the low side driver 34c. The low side driver 34c turns on the low side switching elements 204 to 206 based on the PWM signal. As a result, the charging circuit 400 charges the boot strap capacitors C1 to C3. That is, in the control circuit 300 according to the present embodiment, the constant voltage circuit 38b supplies a constant voltage to the hall amplifier 33, the drive circuit, various protection circuits, or the like, at the timing at which the motor 500 starts to drive.

Thereafter, when the input voltage of the speed control signal becomes equal to or lower than 1.3 V again, the inverter circuit INV12 outputs again the first output control signal to the switching circuit 38a. At this time, the switching circuit 38a is changed from an ON state to an OFF state. Owing to this, a voltage that is supplied to the constant voltage circuit 38b is blocked. As a result, a voltage that is supplied from the regulator 38 to the hall amplifier 33, the drive circuit, various protection circuits, or the like, is blocked.

As described above, the control circuit 300 according to the present embodiment includes the switching circuit 38a and the constant voltage circuit 38b. The switching circuit 38a is switched from an OFF state to an ON state, when the input voltage of the speed control signal exceeds the threshold value. The constant voltage circuit 38b generates a constant voltage based on a voltage that is supplied via the switching circuit 38a and outputs the constant voltage, when the switching circuit 38a is in an ON state. For this reason, when the motor 500 is stopped, a voltage that is supplied to the constant voltage circuit 38b may be stopped. Owing to this, when the motor 500 is stopped, an operation of a circuit or the like that receives the constant voltage from the constant voltage circuit 38b is stopped, and thus it is possible to reduce a standby power.

Particularly, the control circuit 300 according to the present embodiment has a configuration in which the constant voltage circuit 38b may supply a constant voltage to not only the hall amplifier 33 but also the externally attached hall sensors HC1 to HC3. For this reason, when the motor 500 is stopped, a voltage that is supplied to the constant voltage circuit 38b is blocked, whereby only the standby power of the hall amplifier 33 but also the standby power of the externally attached hall sensors HC1 to HC3 may be reduced. Thus, it is possible to increase a reduction effect of standby power.

In addition, in the semiconductor device 100 according to the present embodiment, the speed control signal for generating the PWM signal is used as a signal that switches the switching circuit 38a over to an ON state or an OFF state. That is, it is not necessary to generate a new control signal that controls the switching circuit 38a. Thus, it is possible to reduce standby power, using a simple circuit.

Furthermore, in the switching circuit 38a according to the present embodiment, when the input voltage of the speed control signal is equal to or lower than 1.3 V (when the motor 500 is stopped), the MOS transistor VS1 blocks a voltage that is supplied to the reference voltage circuit 38b1, and the MOS transistor VS2 blocks a voltage that is supplied to the feedback circuit 38b2. Owing to this, it is possible to further reliably block a voltage that is supplied to two circuits which configures the constant voltage circuit 38b.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control circuit, comprising:
a switch circuit configured to switch from an OFF state to an ON state when an input voltage of a control signal for controlling operation of a motor exceeds a predetermined threshold value; and
a constant voltage circuit configured to generate a constant voltage and output the constant voltage based on a voltage supplied via the switch circuit.

2. The control circuit according to claim 1, wherein the control signal controls the number of rotations of the motor according to the input voltage.

3. The control circuit according to claim 1, further comprising:
a comparison circuit configured to compare the input voltage to the predetermined threshold voltage and output an output control signal to the switch circuit, the output control signal indicating whether the input voltage exceeds the predetermined threshold voltage.

4. The control circuit according to claim 3, further comprising:
a drive circuit configured to control a motor drive circuit of the motor according to the control signal and the output control signal,
wherein the comparison circuit is configured to output the output control signal to both the switch circuit and the drive circuit.

5. The control circuit according to claim 4, further comprising:
a hall amplifier configured to amplify a rotation positional signal of the motor and output an amplified rotation positional signal to the drive circuit.

6. The control circuit according to claim 4, further comprising:
a protection circuit configured to receive the constant voltage from the constant voltage circuit and to protect the motor drive circuit.

7. The control circuit according to claim 6, wherein the protection circuit includes at least one of a overheat protection circuit, an overcurrent protection circuit, and a power supply decrease protection circuit.

8. The control circuit according to claim 1,
wherein the constant voltage circuit includes:
a reference voltage circuit configured to generate a reference voltage; and
a feedback circuit configured to compare the reference voltage to a voltage corresponding to the constant voltage, and maintain the constant voltage according to the comparison,
wherein the switch circuit includes:
a first switch connected to the reference voltage circuit; and
a second switch connected to the feedback circuit.

9. A semiconductor device, comprising:
a motor drive circuit connectable to a motor; and
a control circuit configured to control the motor drive circuit, the control circuit including:
a switch circuit configured to switch from an OFF state to an ON state when an input voltage of a control signal for controlling operation of the motor exceeds a predetermined threshold value; and
a constant voltage circuit configured to generate a constant voltage based on a voltage supplied via the switch circuit.

10. The semiconductor device according to claim 9, wherein the control signal controls the number of rotations of the motor according to the input voltage.

11. The semiconductor device according to claim 9, further comprising:
a comparison circuit configured to compare the input voltage to the threshold voltage and output an output control signal to the switch circuit, the output control signal indicating whether the input voltage exceeds the threshold voltage.

12. The semiconductor device according to claim 9, further comprising:
a hall amplifier configured to amplify a rotation positional signal of the motor and output an amplified rotation positional signal to the motor drive circuit.

13. The semiconductor device according to claim 9, further comprising:
a protection circuit configured to receive the constant voltage from the constant voltage circuit.

14. The semiconductor device according to claim 13, wherein the protection circuit is at least one of a overheat protection circuit, an overcurrent protection circuit, and a power supply decrease protection circuit.

15. The semiconductor device according to claim 9, wherein the control signal is a pulse-width-modulated signal.

16. The semiconductor device according to claim 9, further comprising:
a charging circuit connectable to three-phase bootstrap capacitors and configured to charge the three-phase bootstrap capacitors using a direct current power supply potential.

17. A constant voltage output method, comprising:
switching a switch circuit from an OFF state to an ON state when an input voltage of a control signal for controlling operation of a motor exceeds a predetermined threshold value; and
generating a constant voltage and outputting the constant voltage based on a voltage which is supplied via the switch circuit.

18. The method of claim 17, wherein the voltage which is supplied by the switch circuit is a DC voltage.

19. The method of claim 17, further comprising:
comparing the input voltage to the predetermined threshold voltage and outputting an output control signal to the switch circuit, the output control signal indicating whether the input voltage exceeds the predetermined threshold voltage.

20. The method of claim 17, wherein the control signal controls the number of rotations of the motor according to the input voltage.
